(19) United States
(12) Patent Application Publication
(10) Pub. No.: US 2009/0192914 A1
(43) Pub. Date: Jul. 30, 2009

(54) Adaptive Lead Pricing

(76) Inventors: Michael Hood, Irvine, CA (US); Michael Khristo, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/355,997

(22) Filed: Jan. 19, 2009

Related U.S. Application Data
(63) Continuation-in-part of application No. 12/355,983, filed on Jan. 19, 2009.
(60) Provisional application No. 61/022,484, filed on Jan. 21, 2008.
(60) Provisional application No. 61/022,486, filed on Jan. 21, 2008.

(51) Int. Cl. G06Q 30/00; G06Q 10/00; G06N 5/02

(52) U.S. Cl. 705/26; 705/400; 706/52

(57) ABSTRACT

Adaptive lead pricing systems are presented. Users of a lead mining service can use a lead attribute interface to modify a lead's attributes where the attributes can include an attribute value of the lead attribute or attribute metadata bound to the lead attribute. As leads are worked, an analytic engine tracks attribute values and attribute metadata as they vary with time with respect to closing values of the leads. The analytic engine derives correlations among the closing values of the leads, the attribute values, and the attribute metadata by using multi-variate testing techniques. The correlations can be used to adapt a sales price of the lead to form a current price at which the lead is offered to a lead purchaser through a purchasing interface.

This application is a continuation-in-part of U.S. patent application having Ser. No. 12/355,983 filed Jan. 19, 2009, which claims the benefit of priority to U.S. provisional applications having Ser. No. 61/022,484 and 61/022,486 both filed on Jan. 21, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is lead pricing technologies.

### BACKGROUND

Leads can be purchased and sold through various services including those offered by Leadpile™ (http://www.leadpile.com). Such lead providers offer a marketplace where those interested in leads can purchase or sell leads. Such lead marketplaces can offer direct sale of leads at a given price or through auctions.

However, a lead's monetary value (e.g., a lead's price) depends on many factors including various attributes associated with the lead. For example, U.S. patent application publication 2007/0233559 to Golec titled “Acquiring Leads Using Scoring”, describes a system where businesses score the relative importance of various customer attributes. Based on the scoring, a customized lead price can be generated for the businesses. U.S. patent application publication 2008/0201203 to Rose et al. titled “Systems and Method Relating to a Lead Distribution Engine that Uses Margin Scores” describes a similar lead distribution system. Both the above systems require a user of the system to define criteria indicating acceptable leads to them. Unfortunately, as markets shift the criteria could change, which requires the user to update their criteria. Ideally a lead providing service would automatically identify a user's value drivers.

U.S. patent application publication 2008/0086429 to Venkatraman et al. titled “Economic Optimization Engine” offers an interesting approach to pricing products. Venkatraman contemplates setting prices for products based on a sales model, cost model, and rules stemming from product attributes. Additionally, Venkatraman contemplates that each attribute can contribute to a price of a product. Interestingly, such an approach has yet to be applied to leads.

Leads can be considered dynamic products that can change with time due to the nature of the lead itself or how a lead is worked. Leads can comprise one or more attributes having attribute values that vary with time. For example, a lead could include an attribute of “Number of Children” whose attribute value changes from “1” to “2” to “3”, or other attribute value. As attribute values change with time, the monetary value of the lead can also change. Furthermore, a lead's attribute can have an individual contribution to a leads monetary value.

Even in view of the above references known approaches for providing leads to a marketplace only offer a coarse grained approach for valuing a lead based on properties of the lead. However, lead attributes themselves also have characteristics that can affect a monetary value of a lead. The attribute characteristics can be embodied by metadata bound to a lead attribute. Such metadata can include a wide variety of information that describes a lead attribute.

What has yet to be appreciated is that the price of a lead or a group of leads can be considered a dynamic value with respect to changes in the lead's attribute values and to the attribute's metadata. Ideally, a lead provider offering access to leads can adjust the price of a lead as a function of changes in the lead's attributes or based on metadata associated with the attribute. Revenue from the sale of leads can be increased by adapting a lead's priced back on such information.

Thus, there is still a need for methods of establishing a lead's price in response to tracking lead attributes or the attributes metadata.

### SUMMARY OF THE INVENTION

The inventive subject matter provides apparatus, systems and methods in which a lead prices can be adapted based on how attributes of the lead change over time and on metadata associated with the attributes. One aspect of the inventive subject matter includes an adaptive lead pricing system, preferably a computer based system, comprising an attribute interface, an analytic engine, and a lead purchasing interface. A preferred attribute interface allows a user, possibly a lead purchaser or lead seller, to modify attributes of the lead. In some embodiments, the user can modify a value of an attribute or metadata of the lead attribute. The analytic engine is preferably programmed to track values of lead attributes assigned to a plurality of leads as a function of time. As leads are worked by many users (e.g., purchasers or sellers), the engine can determine how the attributes, their values, or metadata affects a price of a lead. The engine is also preferably configured to adapt a sales price of a lead to form a current price for which the lead can be sold. The current price can be determined based on the tracked attribute values or the attribute's metadata. Leads can be offered for sale at their current prices through the purchasing interface.

Users of the contemplated adaptive lead pricing system can include lead purchasers, lead sellers, sources for leads, or a lead mining service that offers access to the interfaces and engines. Once proper authentication of a user is achieved or authorization has been granted, users can modify lead attributes. A user can modify a lead's attribute in various fashions including creating a new attribute, removing an attribute, changing a value of the attribute, adding or removing attribute metadata, or assigning new metadata to the attribute. In some embodiments, lead attributes are modified automatically.

In some embodiments, attribute metadata can be used to restrict access to a lead attribute, possibly by indicating an access level for the attribute. Access levels could include global, public, private, or other definable levels.

Various objects, features, aspects and advantages of the inventive subject matter will become more apparent from the following detailed description of preferred embodiments, along with the accompanying drawings in which like numerals represent like components.

### BRIEF DESCRIPTIONS OF THE DRAWINGS

FIG. 1 is a schematic of a lead mining service that hosts an adaptive lead pricing system.

FIG. 2 is an example attribute interface.

FIG. 3 is an example trend derived by an analytic engine for leads having a common lead attribute over time with respect to value.

FIG. 4 is an example lead purchasing interface.

### DETAILED DESCRIPTION

### Lead Mining Service Overview

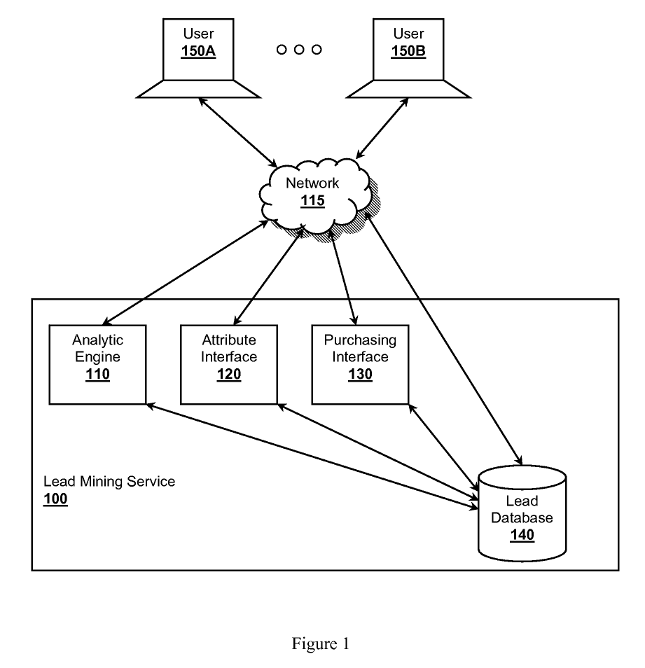

FIG. 1 presents an overview of an environment where lead mining service 100 offers leads to one or more users 150A through 150B, collectively referred to as users 150. A preferred lead mining service 100 hosts an adaptive lead pricing system comprising analytic engine 110, attribute interface 120, or purchasing interface 130. Leads can be stored in lead database 140 and offered to users 150 directly or indirectly possibly through the various elements of service 100. In a preferred embodiment, leads are provided to users 150 over network 115, possibly the Internet.

Lead mining service 100 preferably comprises a for-fee lead providing service. A preferred lead mining service is disclosed in parent U.S. patent application having Ser. No. 12/355,983 titled “Lead Mining, Systems and Methods”. Such approaches to lead mining are embodied by manyUP™ Corporation of Newport Beach, Calif. (http://www.manyup.com) through which leads can be exchanged, distributed, or re-monetized. In the manyUP model, multiple unaffiliated users work leads substantially in parallel. As users 150 work a lead, users 150 modify attributes of the leads, which can improve the lead's monetary value (e.g., the lead's price) to others.

Lead mining service 100 can be embodied by other services or software packages. For example, service 100 could include a Customer Relationship Management (CRM) software package only available internally to a business entity, or externally to multiple business, possibly comprising a Software-as-a-Service (SaaS) CRM that integrates the disclosed techniques. An example CRM SaaS that could benefit from integrating the contemplated adaptive lead pricing system includes SalesForce.com™ (http://www.salesforce.com).

Users 150 represent entities that participate with lead mining service 100. Users 150 can include lead buyers, lead sellers, lead aggregators, CRM providers, lead management systems, or even lead mining services. Users 150 can be embodied by businesses, people, computer systems, or even lead mining service 100.

In a preferred embodiment, users 150 interact with service 100 over network 115. Network 115 preferably comprises the Internet through which unaffiliated users 150 can access leads in service 100. However, network 115 can also comprise other, more private networks including a LAN, WAN, WLAN, VPN, or other forms of networks, wired or wireless.

Leads are preferably stored within database 140 on a storage system (e.g., hard disk, solid state disk, RAID system, SAN, NAS, etc.). Database 140 can be implemented using any suitable database system, possibly including MySQL™, Microsof™ Access™, Oracle™, Postgres SQL™, or other database systems. Database 140 preferably provides capability for searching for leads based on one or more attributes of a lead. In some embodiments, leads are stored as an N-tuple with respect to lead attributes which provides for ease of retrieval for analysis by analytic engine 110. However, any suitable schema for searching, storing, or exchanging leads can be used. It is also contemplated that leads can be serialized or stored using XML as method to exchange leads among one or more third party software packages beyond those available from service 100.

Lead Attributes

Leads represent information about an individual (e.g., a person, organization, business, etc.) that could be potentially interested in receiving information about goods or services. In a preferred embodiment, leads are characterized by one or more lead attributes that describe the lead. Example lead attributes can include, among others, one or more of the following informational items:

(A) Geographical information: Zip code, area code, region, state, country, etc.

(B) Demographic information: Name, age, gender, household information, etc.

(C) Lead history: Age of lead, closing values history, routing, previous sales, views, etc.

(D) Lead source: Other entities, internal or external individuals, lead mining services, etc.

(E) Events: Stock market shifts, mortgage rates, weather conditions, global events, politics, etc.

(F) Monetary Value: Sales price, closing value, costs, etc.

A preferred lead attribute comprises at least a (tag, attribute value) pair. Preferably, tags can be dynamically assigned, created, modified, or removed as necessary as discussed below. Each lead attribute is contemplated to include at least one attribute value associated with the tag, which can change dynamically. In some embodiments, the tag alone is sufficient information where the tag's attribute value could be NULL. In other embodiments, the attribute value associated with the tag changes with time. For example, the age of a lead could have the tag “age” where and its value continually increases as the lead ages.

As an example, consider a scenario where an individual associated with a lead suffers from a weather disaster, possibly hurricane Katrina. The lead can be assigned an attribute that references the event. The attribute could have a tag of “Flood Victim” and a value of “Katrina”. Although the previous example references a weather event that can affect the monetary value of a lead, other events can also affect the monetary value as well. Other events can include news events, political events, financial events (e.g., stock prices, interest rate changes, etc.), earthquakes, personal events, community events, national events, or other events.

Lead attributes represent characteristics of a lead and can include nearly any piece of information that users 150 would find valuable. Preferred attributes are those that are associated with the value drivers of users 150, where a value driver is considered to be at least a combination of lead attributes, attribute values, or attribute metadata. For example, a mortgage broker lead consumer could use a type of mortgage as an attribute. Alternatively, a political candidate could use a party affiliation as an attribute.

As discussed above, attributes preferably include a (tag, attribute value) pair where the tag is an identifier that can be represented by alphanumeric data and where the attribute value represents a numeric, or possibly logical, value of the tag. Although a preferred value in a (tag, attribute value) pair is a logical or numerical value, it is also contemplated that the value can include other data representations including strings, enumerations, or other structures. In some embodiments, an attribute value can be an array having multiple data entries to indicate various aspects associated with a tag.

An attribute could include a tag represented by the string “Pool?” and the value could be represented logically as 0 for “no” and 1 for “yes”. Such logical attribute values can be represented in a user interface as a simple check box associated with the tag. An alternative example of a value attribute includes a tag “Children” where the attribute value can be 0, 1, 2, or more depending on the number of children the individual associated with the lead has.

Within the contemplated system, lead attributes can be assigned an identifier used to reference leads. Lead mining service 100 can use the attribute identifiers to assign attributes to leads or to reference attributes from leads. Contemplated identifiers can include GUIDs, UUIDs, or other identification schemes. Treating lead attributes as separately references entity or object, provides many benefits. One benefit includes that single lead attribute can be analyzed as an object across many different leads. Additionally, a lead attribute as initially created can be treated as a template that can be assigned to a lead, which can then have its attribute values or attribute metadata tailored to the lead to which it is assigned.

Attribute Metadata

In a preferred embodiment, lead attributes are tagged with metadata that characterizes the attribute. For example, an attribute could have metadata that represents a user that created the attribute or assigned the attribute to the lead, a standardized name for the tag, a time stamp, or other metadata. Metadata preferably includes digital data representing strings, numbers, arrays, tuples, logical values, or other information.

Attribute metadata can be stored along with a lead's attribute using any suitable scheme. One acceptable method for storing attribute metadata includes storing a reference pointer along with the attribute that points to the stored metadata of the lead's attribute. Such an approach provides for forming a classification scheme of lead information. For example, a lead's data can be stored hierarchically where a lead's ID represents a root, which then can then point to lead attributes, which in turn points to lead metadata. As with the lead, attribute metadata can also be stored or exchanged using XML.

Attribute metadata can comprise common metadata pertaining to just the attribute, or can comprise specific metadata pertaining an aspect of the lead with respect to the attribute. An example of common metadata includes data indicating which user 150 initially created the attribute. No matter to which lead the attribute is assigned, the metadata remains common across all leads having the same attribute. In embodiments where attributes are treated as a template attribute, the common metadata can be stored with the template information. An example of specific metadata includes data possibly indicating when an attribute was assigned to a lead, or indicating who last updated the attribute. Specific metadata can be different from one lead assigned the attribute to a different lead having the same attribute where the specific metadata for each lead's attribute is specific to the lead.

Numerous benefits can be realized through the use of attribute metadata. One benefit includes the ability to track of history of a lead attribute as a separate entity from leads, which allows lead mining service 100 or even users 150 to determine if such an attribute has value or not. Additionally, attribute metadata aids in tracking a history of a lead attribute by allowing modification history information to be bound to the attribute for a lead. In both cases, the historical information can be used to establish trends with respect to an attributes' contribution to a monetary value of a lead. For example, when lead attributes are tracked as a separate entity, a trend could indicate that a lead attribute fails to contribute to the monetary value of one or more leads indicating that the lead attribute might need to be removed from the leads.

Attribute metadata can be used as a means for classifying lead attributes. Each attribute can include metadata tags that indicated how the attribute should be grouped. The group tag information can then be used to present users 150 a listing of available attributes for a lead where the lead also pertains to the group. For example, attributes could include a common metadata tag of “mortgage”. When a user 150 is working with leads relating to mortgages, user 150 can be offered an option to assign any attributes having the common metadata tag “mortgage” to the lead.

It is specifically contemplated that attribute metadata can be classified within a lead attribute name space, possibly a hierarchical name space. Preferred name spaces include those describing goods or services.

Example attribute metadata can include many different types of tags. One type of tag includes time stamps that possibly indicate when a lead attribute was created, assigned, modified, or had its attribute values changed. Another type of tag includes an identifier that can be used to identify the attribute, or a user 150 that created the attribute or that modified the attribute. Yet another type of tag can include access levels that indicate which of user of users 150 is permitted to access or to view an attribute. For example, an attribute could have access level metadata indicating the attribute is globally accessible to everyone, internally accessible to those affiliated with a specific user 150, private to a single user 150, public, protected, or otherwise restricted from access. Still another type of metadata could include a timer that indicates when an attribute is made available for viewing or for modification, or that indicates how long a lead should lay fallow. It should be noted that many other types of metadata can be used to tag a lead attribute beyond those listed above, all of which are contemplated and fall within the scope of the inventive subject matter.

One should appreciate that attribute metadata can be leveraged as a value driver for users 150. The information conveyed via attribute metadata can aid in determining relevant trends for leads having acceptable closing values for one or more users. For example, attribute metadata can be used to differentiate the monetary contribution of an attribute from one of user 150 to a different user 150. Such an approach provides for fine grain pricing of leads as discussed below.

Attribute Interface

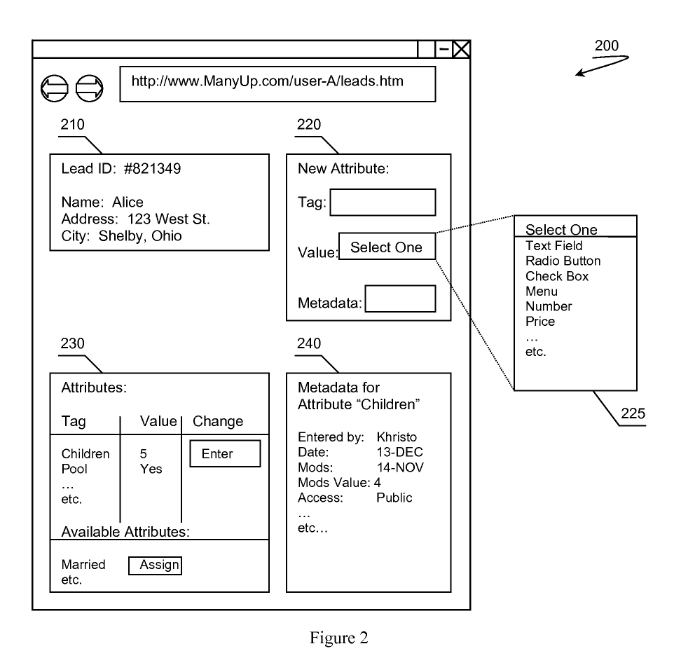

FIG. 2 illustrates a possible attribute interface 200 through which a user working lead 210 can access one or more lead attributes within an adaptive lead pricing system. Although attribute interface 200 is presented as a web page, it is specifically contemplated that interface 200 can be embodied using many different techniques. As used herein, the term “interface” is used to represent a computing device storing software instruction on a computer readable medium (e.g., RAM, flash, hard disks, solid state disks, etc.) where the computing device executes the software instructions to provide the functionality of the interface. It should be appreciated “interfaces” are considered to include hardware specifically adapted via software. For example, an interface can be implemented via a web server serving a web page, a personal computer running a local software application presenting user interface (e.g., a GUI) to the user, an computer offering an Application Program Interface (API) locally to a user's software package, a remote computer offering an API available over a network (e.g., a web service), or a one or more computer systems operating as a SaaS implementation.

Embodiments where interface 200 comprises an API, either local or remote, provides for integrating the disclosed inventive subject matter with third party software. For example, a database package could call into local software attribute interface libraries to gain access to lead attribute information. Additionally, third party offerings, possibly a CRM SaaS, could access one or more web services that provide access to lead attribute information.

Attribute interface 200 is preferably configured to allow a user to modify a lead attribute for lead 210 by updating an attribute (e.g., its tag, values, or metadata), adding an attribute to lead 210, removing an attribute from lead 210, defining a new attribute, or otherwise altering an attribute of lead 210. For example, a user can utilize creation component 220 to define a new lead attribute that can be assigned to lead 210 by entering a new tag, available values, or metadata. As shown, it is contemplated that types of attribute values can be selected from menu 225. Once a user selects a type of value, they can define acceptable attributes values if necessary. Attribute values can be presented to a user based on many different UI objects including radio buttons, check boxes, text or number fields, drop down lists, sliders, menus, or other objects. Although components 210, 220, 230, or 240 are illustrated as being separate, it is also contemplated that the components can be aggregated together in any combination, combined or alone, to form interface 200.

As users create new attributes for leads, the new attributes can be made available to other users, possibly even different unaffiliated lead purchasers (e.g., lead purchasers having different employers). For example, a first lead purchaser can create a new lead attribute for which the first purchaser has interest. A second lead purchaser, different from the first, could view leads having the new attribute to determine if such leads are also of interest to the second purchaser. Furthermore, the second lead purchaser could modify the new lead attribute as they work the lead.

In a preferred embodiment, a lead mining service providing leads is configured to automatically modify lead attributes. As a lead flows through the service from user-to-user or form purchaser-to-seller, the lead mining service can update attributes or attribute metadata via attribute interface 200 to reflect various stages of the lead's life cycle. Contemplated updates to a lead attribute or its metadata can include a log of purchases, sales, an initial sales price, modifications, timers, alerts, notifications, or other information.

Additionally, a user could utilize modification component 230 to change an existing lead attribute or to assign an existing lead attribute to lead 210. For example, a user could update the attribute value of the “Children” attribute from five to six. Furthermore, the user could select an available attribute to be assigned to lead 210. It is specifically contemplated that a user, possibly a lead seller, can set an initial sales price of the lead via attribute interface 200.

In some embodiments, the available attributes are listed based on metadata tags assigned to the attributes, possibly based on a classification scheme. If the classification metadata of the attribute corresponds to the classification of a lead or other attributes, the attribute can be shown. If no such correspondence can be determined, attributes can be restricted from view.

It is also contemplated that metadata assigned to an attribute can be viewed via metadata component 240, assuming proper authentication or authorization has been granted to the user. Once a user receives appropriate permission, the user can not only view metadata but can also modify metadata as desired. It is specifically contemplated that a lead mining service hosting the contemplated adaptive lead pricing system can modify the lead attribute including its metadata.

Analytic Engine

Preferred adaptive lead pricing systems also comprise an analytic engine 110. A preferred analytic engine 110 comprises software instructions stored on a computer readable media that are configured to analyze the flow of leads through a lead mining service to derive a monetary value of a lead to a user. As used herein, the term “engine” is used to represent a computing device storing software instruction on a computer readable medium (e.g., RAM, flash, hard disks, solid state disks, etc.) where the computing device executes the software instructions to provide the functionality of the analytic engine. As with interfaces, one should appreciated the “analytic engine” is considered to include hardware specifically adapted via analysis software as discussed below.

An analytic engine 110 is preferably configured to track an attribute's attribute value as a function of time among many different leads that are assigned the attribute. As users work leads by modifying lead attributes, the engine can derive trends or relationships among the attributes and acceptable closing values for one or more users. The analytic engine 110 can utilize one or more algorithms to derive relationships or correlations. Contemplated algorithms include automated multi-variate testing algorithms that track closing value of leads with respect to attributes, attribute values, or metadata. Suitable multi-variate testing that can be incorporated into the analytics engine include the Taguchi method, which is ordinarily used for quality management. Other acceptable multi-variate testing can be incorporated including regression analysis, canonical variate analysis, principle components analysis, linear discriminate analysis, logistic regression, artificial neural networks to establish non-linear variates, multidimensional scaling, recursive partition, or other analysis methods. In a preferred embodiment, an analytic engine 110 can establish linear relationships as well as non-linear relations.

Analytic engine 110 can also filter data that is used for trend analysis to ensure the analysis results are customized to specific user. Engine 110 preferably filters which leads or lead attributes are used for an analysis be filtering on attribute metadata. Attribute metadata could indicate attributes defined by the user or could indicate attributes belonging to class of attributes of interest to the user.

It is also contemplated that an analytic engine 110 can include an adapted version of the techniques disclosed in U.S. patent application publication 2008/0086429 to Venkatraman et al. titled “Economic Optimization Engine”. Such an approach provides for determining how a lead attribute can contribute as a value driver to a monetary value of a lead. In a preferred embodiment, the value driver can be multiply dependent (e.g., having more than one dimension) where the driver is dependent on one or more attributes, attribute values, or attribute metadata where each of the elements can interact with each other. The elements can interact constructively to enhance a monetary value of a lead, or destructively to detract from a monetary value of a lead. A preferred analytic engine 110 utilizes the above algorithms to identify constructively or destructively interfering lead attributes, attribute values, or attribute metadata.

One should note that a preferred analytic engine 110 operates by deriving a user's intent or needs before they realize it themselves. Such an approach eliminates a requirement where a user inputs scores or other criteria characterizing desirable leads. One should also appreciate that that desirable criteria of a lead can change over time as consumers in a market shift or through other events. Rather than requiring a user to identify such shifts, the preferred analytic engine 110 can discern the shifts automatically by identifying value drivers as correlations are derived among lead attributes, attribute metadata, and lead closing values for a user. Preferably the identified value drivers are fed back to the user to aid the user in developing their marketing or sales campaigns. One should note the value drivers can also vary with time and can be presented graphically to the user via trend charts, or any other desirable form.

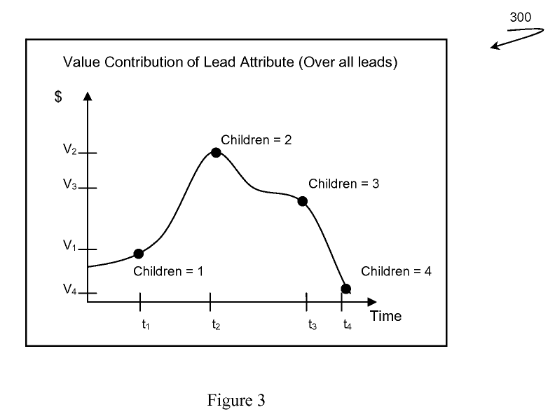

For clarity purposes, FIG. 3 presents a simple example trend 300 identified by a preferred analytic engine 110. A group of leads have been assigned an attribute tagged as “Children”. As the leads have been worked, the corresponding value attributes have changed from one through four indicating individuals associated with the leads have an equivalent number of children. Attribute metadata representing a time stamp of when the children attribute is modified indicates that leads having one child will likely have another child in the time period defined by t₂-t₁ Such leads, will likely increase in closing value from V₁ to V₂ due to the children attribute value changing from one to two. As leads are worked by various users, either affiliated with each other or unaffiliated, their closing values are also tracked, preferably in a monetary value. In the simple example shown in FIG. 3, analytic engine 110 determines a correlation among (1) the closing values of leads, (2) the attribute values of the lead attributes, and (3) the metadata of the lead attributes (e.g., the modification times).

In some embodiments analytic engine 110 can determine if a lead or a group of leads assigned a common attribute should lay fallow for a period of time. In the example above, leads having the children attribute with an attribute value of one might increase in value by simply waiting for a time period of t₂-t₁ Other reasons why a lead or a group of leads might benefit from laying fallow include reducing the number of calls to an individual associated with a lead, allowing lead attributes to timeout, or allowing an individual associated with the lead to reach a certain age or life-stage, or for other reasons.

A lead can lay fallow for all users, for a group of users, or just for a single user. Allowing a lead to lay fallow with respect to just a few users provides for allowing other users to continue to work a lead, which can result in the lead increasing in value to the few or a single user.

Once the analytic engine 110 gains insight into how attributes, attribute values, or metadata affects the closing value of a lead, the engine can adjust a price for which the lead can be sold. Furthermore, the analytic engine 110 can differentiate value drivers from one user to another. In a preferred embodiment, engine 110 adapts a sales price of a lead based on identified the correlations by adapting the sales price through increasing or decreasing the price to form a current price at which the lead is offered for sale. The amount by which the sales price is adapted is preferably a function of the tracked attribute values and metadata with respect to their contribution to the monetary value of the lead, or more preferably their contribution to the monetary value of the lead for a specific user. In some embodiments, the amount adjusted can be a percentage (e.g., 5%, 10%, 20%, 50%, etc.) of the predicted closing values. All algorithms for calculating an adjustment amount based on correlations of closing values, lead attributes, attribute metadata, or user value drivers are contemplated.

Based on an analysis of leads having similar attributes, attributes values, and metadata, a preferred analytics engine 110 can also form a prediction of the monetary value of a lead at a future date. Referring back to FIG. 3, a lead with a children attribute having an attribute value of one might be predicted to have a closing value of V₂ at time t₂. Analytic engine 110 can use the prediction information to derive a future price at which a lead might be sold at a future date. In a preferred embodiment, a lead purchaser is offered a lead for sale where the offer includes a current price less than the future price. The offer can also present the user with the predicted future price, and a time when the future price is expected to be effective. Such an approach provides for offering advanced sale of leads at discounted prices.

Establishing a future price prediction provides for selling leads at a premium to entities that hope the value of the lead will increase over time. For example, leads that correspond to individuals having ARM mortgages might become more valuable to lenders as mortgage rates of ARM mortgages change. For such a case, the provider predicts a future price of the lead based on the lead's mortgage attributes. Preferably, the future prices are predicted out to at least three months. Price predictions out to at least one year, or at least five years are also contemplated.

Given the statistical nature of the analysis of leads, results derived from analytic engine 110 can include a measure of precision or error, possibly a represented by a width of a Gaussian or Poisson distribution. In some embodiments, the measure of precision of a result can also be used to guide how to adapt a sales price to arrive at a current price. When the precision has a small value indicating a well measured result, the sales price for a lead can be increased. When the precision has a large value indicating a less precise result, the sales price of the lead can be decreased.

Purchasing Interface

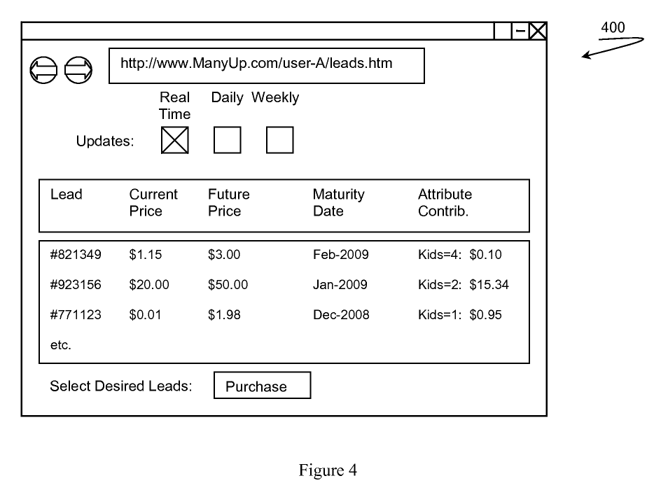

In FIG. 4, once a current price is formed for a lead, the lead can be offered to a lead purchase at the current price via purchasing interface 400. As with attribute interface 200, purchasing interface 400 can take on many different forms, which can comprise a web page as shown, a software user interface, an Application Program Interface (API) locally available to a user's software package, an API remotely available to a user via a network (e.g., a web service), or a SaaS implementation, or other interface accessible to a human or machine.

In a preferred embodiment, purchasing interface 400 presents one or more leads available for purchase at the current price. In some embodiments, interface 400 also presents a future price at which a lead is likely to be offered along with a date or other time indicating when the future price is to be effective (e.g., a maturity date). Leads can be presented individually as show, or as a group or bulk package of leads, possibly having at least one lead attribute in common.

It is also contemplated that purchasing interface 400 can also display one or more value drivers for a lead purchaser. As show, a value driver is presented as a lead attribute “Kids”. However, a value driver could include a combination of a lead attribute, an attribute value, or attribute metadata.

Purchasing interface 400 can also restrict a lead purchaser's access to lead attribute information. For example, lead attributes can have metadata indicating an access level for the lead attribute. If a lead purchaser lacks permission or access to a lead attribute, the attribute would not be shown to the purchaser. It is also contemplated that interface 400 can be configured to filter leads or other lead attributes based on attribute metadata.

As leads are worked by multiple users of within a preferred lead mining service, attributes of the leads can be expect to change even as leads are offered for sale. Leads offered for sale through purchasing interface 400 can be updated periodically to reflect changes to the lead or its current price. For example, the current price could incrementally increase toward the future price. Updates can be performed in real-time as an analytic engine adapts the sales prices reflecting changes in the leads, or updates could occur daily, weekly, monthly, or other configurable time periods.

In some embodiments, purchasing interface 400 can be integrated into a lead auctioning system where a user offers one or more leads for auction at a sales price. Lead purchasers can then bid on the leads. In such an embodiment, the current price comprises a bid price portion and a base portion established by the contemplated analytic engine.

Thus, specific embodiments and applications of lead pricing have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An adaptive lead pricing system, comprising:
an attribute interface through which a user is able to modify a lead attribute having an attribute value and attribute metadata;
an analytic engine configured (a) to track the attribute value as a function of time among a plurality of leads having the lead attribute, (b) to adapt a sales price of the lead to form a current price of the lead based on the tracked attribute value and on the attribute metadata; and
a lead purchasing interface through which the lead is offered for sale to a first lead purchaser at the current price.

2. The system of claim 1, wherein the attribute interface allows the user to define a new lead attribute for the lead.

3. The system of claim 2, wherein the user is a second lead purchaser different from the first lead purchaser.

4. The system of claim 2, wherein the user is a lead mining service.

5. The system of claim 4, wherein the lead mining service is configured to automatically modify the lead attribute of the lead.

6. The system of claim 1, wherein the attribute interface allows the user to set the sales price for the lead.

7. The system of claim 1, wherein the purchasing interface is configured to restrict access to the lead attribute based on its attribute metadata.

8. The system of claim 7, wherein the attribute interface provides for assigning metadata to the lead attribute.

9. The system of claim 1, wherein the attribute metadata indicates an access level for the lead attribute.

10. The system of claim 9, wherein the access level indicates private access to the lead purchaser.

11. The system of claim 1, wherein the analytic engage is further configured to allow a lead to lay fallow for a period of time

12. The system of claim 1, wherein the current price is less than a predicted future price, and where the lead purchasing interface presents both the current price, the future price, and a time when the future price is expected to be effective.

13. The system of claim 1, wherein the lead purchasing interface is configured to offer a set of leads for sale where each member of the set of leads has the lead attribute in common with the lead.

14. The system of claim 1, wherein the lead purchasing interface is configured to update a display of the current price.

15. The system of claim 1, wherein the current price comprises a bid from a second lead purchaser.

16. The system of claim 1, further comprising a lead database storing the plurality of leads.

17. The system of claim 17, wherein the analytics engine is further configured to establish a trend with respect to the lead attribute and attribute metadata based on closing values of at least some of the plurality of leads, and to adapt the sales prices based on the trend.

18. The system of claim 1, wherein the lead attribute comprises a reference to an event.

19. The system of claim 1, wherein the analytics engine is further configured to determine the lead attribute's contribution to the current price.

20. The system of claim 19, wherein the purchasing interface display's the lead attribute's contribution to the current price.
